(19) United States
(12) Patent Application Publication
(10) Pub. No.: US 2022/0146274 A1
(43) Pub. Date: May 12, 2022

(54) NAVIGATION DEVICE

(71) Applicant: TOYOTA JIDOSHA KABUSHIKI KAISHA, Toyota-shi (JP)

(72) Inventor: Takuya NAKAGAMI, Toyota-shi (JP)

(73) Assignee: TOYOTA JIDOSHA KABUSHIKI KAISHA, Toyota-shi (JP)

(21) Appl. No.: 17/454,233

(22) Filed: Nov. 9, 2021

(30) Foreign Application Priority Data
Nov. 11, 2020 (JP) 2020-188089

(51) Int. Cl. G01C 21/34; G01C 21/36

(52) U.S. Cl. CPC G01C 21/3469; G01C 21/3682

(57) ABSTRACT

A navigation device includes: a display; and a controller configured to obtain a first remaining amount which is an energy remaining amount of traveling energy of the vehicle, obtain a travelable distance of the vehicle at the first remaining amount, obtain a current position of the vehicle, obtain a first traveling route from the current position to a destination, obtain a predicted remaining amount which is calculated based on a length of the first traveling route and the travelable distance and is a prediction value of the energy remaining amount at a point of time at which the vehicle arrives at the destination, obtain supply facility information which indicates a service state of at least one supply facility including equipment which supplies the traveling energy to the vehicle, and display a traveling route from the current position to the destination on the display, wherein the controller displays a second traveling route from the current position to the destination via the supply facility whose service state is open now or at a point of time at which the vehicle arrives at the supply facility on the display when the predicted remaining amount is the second remaining amount or less.

### CROSS REFERENCE TO RELATED APPLICATIONS

This application claims priority to Japanese Patent Application No. 2020-188089, filed Dec. 11, 2020, the disclosure of which is incorporated by reference herein in its entirety.

### BACKGROUND

### Field

The present disclosure relates to a navigation device.

### Related Art

JP-A-2012-057955 discloses a navigation device of a vehicle which guides a recommended route from a current position to a destination. When a fuel remaining amount of the vehicle becomes a predetermined value or less, this navigation device proposes a fuel supply facility which exists within a predetermined range from the current position as a via-point.

Patent Literature 1: JP-A-2012-057955

The navigation device of JP-A-2012-057955 does not take into account, for example, the fuel remaining amount of the vehicle at a point of time at which the vehicle arrives at the destination, and a service state of the fuel supply facility. Therefore, a navigation device which enables more convenient route guidance regarding a fuel supply is demanded.

### SUMMARY

One aspect of the present disclosure provides a navigation device of a vehicle. This navigation device includes: a display; and a controller configured to obtain a first remaining amount which is an energy remaining amount of traveling energy of the vehicle, obtain a travelable distance of the vehicle at the first remaining amount, obtain a current position of the vehicle, obtain a first traveling route from the current position to a destination, obtain a predicted remaining amount which is calculated based on a length of the first traveling route and the travelable distance and is a prediction value of the energy remaining amount at a point of time at which the vehicle arrives at the destination, obtain supply facility information which indicates a service state of at least one supply facility including equipment which supplies the traveling energy to the vehicle, and display a traveling route from the current position to the destination on the display, wherein the controller displays the first traveling route on the display when the predicted remaining amount exceeds a second remaining amount which is the energy remaining amount which satisfies a preset condition, and displays a second traveling route from the current position to the destination via the supply facility whose service state is open now or at a point of time at which the vehicle arrives at the supply facility on the display when the predicted remaining amount is the second remaining amount or less.

### BRIEF DESCRIPTION OF THE DRAWINGS

FIG. 1 is an explanatory view illustrating a schematic configuration of a route guidance system according to a first embodiment;

FIG. 2 is an explanatory view illustrating a schematic configuration of a navigation device according to the first embodiment;

FIG. 3 is a flowchart illustrating contents of route presentation processing; and

FIG. 4 is an explanatory view illustrating an example of a traveling route presented by the route presentation processing.

### DETAILED DESCRIPTION

### A. First Embodiment

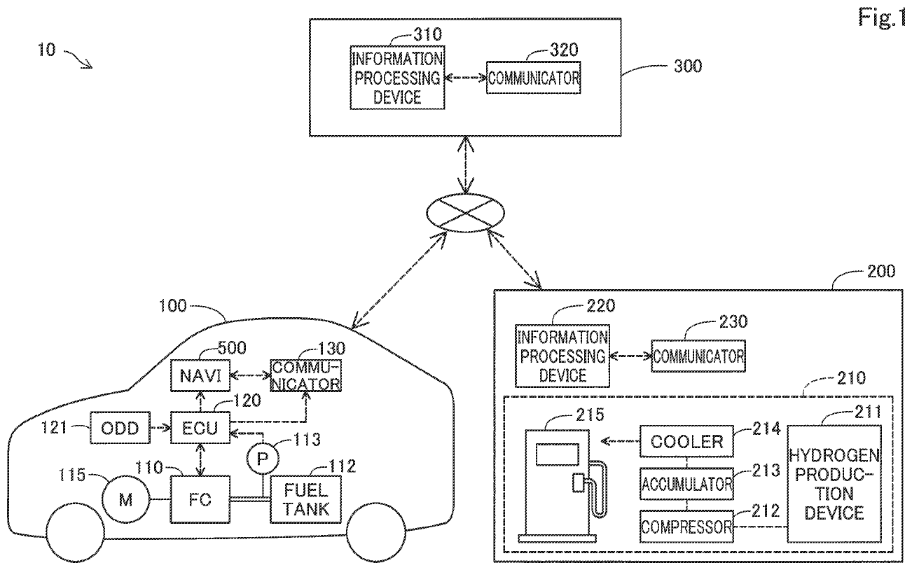

FIG. 1 is an explanatory view illustrating a schematic configuration of a route guidance system 10 according to the first embodiment. In the first embodiment, the route guidance system 10 includes a vehicle 100, a supply facility 200 and a management center 300. Although the number of the supply facilities 200 illustrated in FIG. 1 is one, the route guidance system 10 includes a plurality of supply facilities 200.

In the present embodiment, the vehicle 100 is a fuel cell vehicle which travels using a hydrogen gas as a fuel. The vehicle 100 includes a fuel cell 110, a fuel tank 112, a pressure sensor 113, a traveling motor 115, a vehicle control device 120, an odometer 121, a navigation device 500 and a communicator 130. In this regard, the vehicle 100 is not limited to the fuel cell vehicle, and may be, for example, a gasoline vehicle which travels using a gasoline as a fuel, a diesel vehicle which travels using a light oil as a fuel, or a Liquid Petroleum Gas (LPG) vehicle which travels using an LPG as a fuel. The vehicle 100 may be a car or may be a motorcycle. The vehicle 100 may be an electric car or an electric motorcycle which travels using electric power stored in a battery.

The fuel cell 110 generates electric power by using a hydrogen gas stored in the fuel tank 112, and air taken in from an atmosphere. The fuel tank 112 is provided with the pressure sensor 113 which measures a pressure of the hydrogen gas stored in the fuel tank 112. The traveling motor 115 is driven by the electric power generated by the fuel cell 110, and causes the vehicle 100 to travel.

The vehicle control device 120 is an Electronic Control Unit (ECU). The vehicle control device 120 controls electric power generation of the fuel cell 110 and electric power supply to the traveling motor 115.

The vehicle control device 120 obtains a remaining amount of the hydrogen gas stored in the fuel tank 112. For example, the vehicle control device 120 obtains the pressure of the hydrogen gas measured by the pressure sensor 113, and obtains the remaining amount of the hydrogen gas stored in the fuel tank 112 by using a map or a function which expresses a relationship between the pressure of the hydrogen gas measured by the pressure sensor 113 and the remaining amount of the hydrogen gas of the fuel tank 112.

The vehicle control device 120 obtains fuel efficiency of the vehicle 100. For example, the vehicle control device 120 obtains the fuel efficiency of the vehicle 100 based on an increase degree of a traveling distance measured by the odometer 121 of the vehicle 100 and a decrease degree of the remaining amount of the hydrogen gas in the fuel tank 112.

The navigation device 500 guides a traveling route of the vehicle 100 from a current position to a destination to an occupant of the vehicle 100. The occupant is not limited to a driver, and has a meaning also including a passenger. The navigation device 500 can perform bidirectional communication with the management center 300 by wireless communication via the communicator 130. In this regard, a configuration of the navigation device 500 will be described later.

The supply facility 200 includes equipment 210 which supplies a fuel to the vehicle 100, an information processing device 220 and a communicator 230. In the present embodiment, the supply facility 200 is a hydrogen station which supplies a hydrogen gas to the fuel tank 112 of the vehicle 100 which is the fuel cell vehicle. In this regard, in a case where the vehicle 100 is not the fuel cell vehicle but the gasoline vehicle, the diesel vehicle or the LPG vehicle, the supply facility 200 is configured as a gas station which includes equipment which supplies a fuel used for the gasoline vehicle, the diesel vehicle or the LPG vehicle. In a case where the vehicle 100 is not the fuel cell vehicle but the electric car or the electric motorcycle, the supply facility 200 is configured as a charging station which includes equipment which supplies electric power to the battery mounted on the electric car or the electric motorcycle.

According to the present embodiment, the supply facility 200 includes a hydrogen producing device 211, a compressor 212, an accumulator 213, a cooler 214 and a dispenser 215 as the above-described equipment 210. The hydrogen producing device 211 produces a hydrogen gas by using, for example, a town gas or an LPG as a raw material. The hydrogen producing device 211 may produce the hydrogen gas by electrolyzing water. The pressure of the hydrogen gas produced by the hydrogen producing device 211 is raised to, for example, 80 MPa by the compressor 212, and then the hydrogen gas is stored in the accumulator 213. The hydrogen gas stored in the accumulator 213 is cooled to minus 40 degree Celsius by the cooler 214, and then is supplied to the dispenser 215. The dispenser 215 fills the hydrogen gas to the fuel tank 112 of the vehicle 100. When the hydrogen gas is filled in the fuel tank 112, a temperature of the hydrogen gas is raised by adiabatic compression. The hydrogen gas is cooled in advance by the cooler 214, so that an excessive rise in the temperature of the fuel tank 112 at a time when the hydrogen gas is filled in the fuel tank 112 is suppressed. Cooling the hydrogen gas in advance by the cooler 214 is referred to as pre-cooling processing. In addition, the supply facility 200 is not limited to an on-site type which includes the above-described hydrogen producing device 211, and may be an off-site type which does not include the hydrogen producing device 211 and stores in the accumulator 213 a hydrogen gas transported from other places.

The information processing device 220 is configured as a computer which includes a CPU, a memory and an input/output interface. The information processing device 220 can perform bidirectional communication with the management center 300 by wired communication or wireless communication via the communicator 230.

The information processing device 220 receives an input of supply facility information including information which indicates a service state of the supply facility 200. In the present embodiment, the information processing device 220 receives an input of one state of open, closed and under maintenance as the service state. Open means a state in which the supply facility 200 can supply a hydrogen gas to the vehicle 100. Closed means a state in which the supply facility 200 cannot supply the hydrogen gas to the vehicle 100 due to a reason such as an outside of business hours or a regular holiday. Under maintenance means a state in which the supply facility 200 cannot supply the hydrogen gas to the vehicle 100 due to a reason such as inspection or repair of the equipment 210. The supply facility information is transmitted to the management center 300 via the communicator 230.

The management center 300 includes an information processing device 310 and a communicator 320. The information processing device 310 is configured as a computer which includes a CPU, a memory and an input/output interface. The information processing device 310 performs bidirectional communication with the vehicle 100 or the supply facility 200 via the communicator 320. In the present embodiment, the information processing device 310 receives pieces of the supply facility information from a plurality of supply facilities 200 via the communicator 130, and transmits the pieces of supply facility information of a plurality of supply facilities 200 to the vehicle 100.

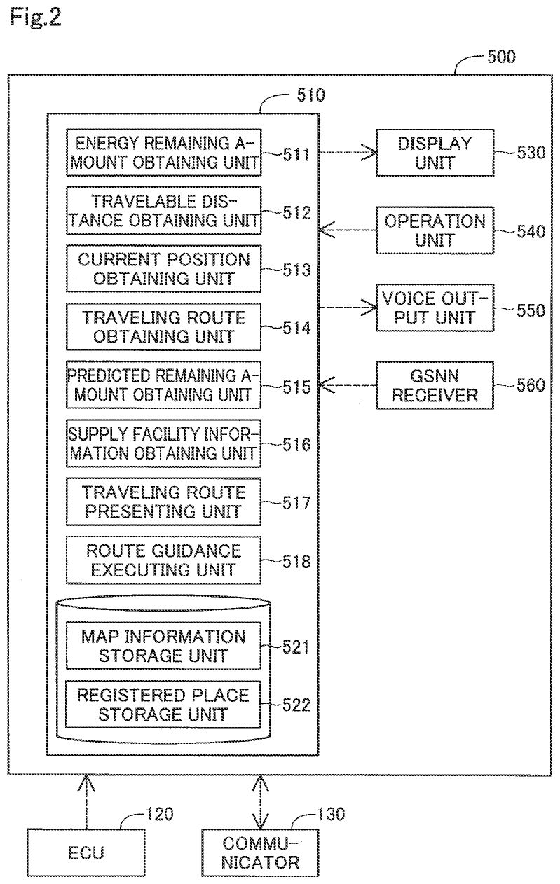

FIG. 2 is an explanatory view illustrating a schematic configuration of a navigation device 500. The navigation device 500 includes a control unit 510, a display unit 530, an operation unit 540, a voice output unit 550 and a GNSS receiver 560.

The display unit 530 is configured with, for example, a liquid crystal monitor. The operation unit 540 includes, for example, a touch panel or a push button provided to the liquid crystal monitor. The voice output unit 550 is a speaker. The GNSS receiver 560 receives from a GNSS satellite a radio wave for obtaining a current position of the vehicle 100. The GNSS is an abbreviation of the Global Navigation Satellite System. In the present embodiment, the GNSS receiver 560 receives a radio wave from a Global Positioning System (GPS) satellite.

The control unit 510 is configured as a computer which includes a CPU, a memory and an input/output interface. The control unit 510 includes an energy remaining amount obtaining unit 511, a travelable distance obtaining unit 512, a current position obtaining unit 513, a traveling route obtaining unit 514, a predicted remaining amount obtaining unit 515, a supply facility information obtaining unit 516, a traveling route presenting unit 517, a route guidance executing unit 518, a map information storage unit 521 and a registered place storage unit 522. The energy remaining amount obtaining unit 511, the travelable distance obtaining unit 512, the current position obtaining unit 513, the traveling route obtaining unit 514, the predicted remaining amount obtaining unit 515, the supply facility information obtaining unit 516, the traveling route presenting unit 517 and the route guidance executing unit 518 are realized like software when the CPU executes programs stored in the memory. The map information storage unit 521 and the registered place storage unit 522 are provided in the memory of the control unit 510.

The energy remaining amount obtaining unit 511 obtains an energy remaining amount of traveling energy of the vehicle 100. The traveling energy has a meaning also including a fuel, which generates energy for causing the vehicle 100 to travel in addition to energy for causing the vehicle 100 to travel. The energy remaining amount has a meaning including a remaining amount of a fuel which generates energy for causing the vehicle 100 to travel in addition to a remaining amount of energy for causing the vehicle 100 to travel. That is, in a case where the vehicle 100 is the fuel cell vehicle as in the present embodiment, the traveling energy is a hydrogen gas, and the energy remaining amount is a remaining amount of the hydrogen gas loaded to the vehicle 100. In the present embodiment, the energy remaining amount obtaining unit 511 obtains the remaining amount of the hydrogen gas stored in the fuel tank 112 via the vehicle control device 120. In addition, in a case where the vehicle 100 is not the fuel cell vehicle but the gasoline vehicle, the diesel vehicle or the LPG vehicle, the traveling energy is a gasoline, a light oil or an LPG loaded as a fuel to the gasoline vehicle, the diesel vehicle or the LPG vehicle, and the energy remaining amount is a remaining amount of the gasoline, the light oil or the LPG loaded to the gasoline vehicle, the diesel vehicle or the LPG vehicle. In a case where the vehicle 100 is not the fuel cell vehicle but the electric car or the electric motorcycle, the traveling energy is electric power, and the energy remaining amount is a remaining amount of the electric power stored in the battery mounted on the electric car or the electric motorcycle.

The travelable distance obtaining unit 512 obtains a travelable distance of the vehicle 100 at the energy remaining amount obtained by the energy remaining amount obtaining unit 511. The travelable distance means the rest of a distance which the vehicle 100 can travel without receiving a supply of the traveling energy. In the present embodiment, the travelable distance obtaining unit 512 obtains the travelable distance calculated based on the remaining amount of the hydrogen gas obtained by the energy remaining amount obtaining unit 511, and the fuel efficiency of the vehicle 100 obtained from the vehicle control device 120. In addition, the vehicle 100 may include a battery which stores regenerative electric power generated by the traveling motor 115, and calculate the travelable distance by taking into account a distance which the vehicle 100 travels using the regenerative electric power when traveling by using the regenerative electric power stored in the battery. In the case where the vehicle 100 is the electric car or the electric motorcycle, or the case where the vehicle 100 is the gasoline vehicle, the diesel vehicle or the LPG vehicle configured as a hybrid vehicle which includes a traveling motor and a battery in addition to an engine, the travelable distance may be calculated by taking into account a distance which the vehicle 100 travels using the regenerative electric power.

The current position obtaining unit 513 obtains the current position of the vehicle 100. In the present embodiment, the current position obtaining unit 513 obtains the current position of the vehicle 100 by using the radio wave received by the GNSS receiver 560 from the GNSS satellite.

The traveling route obtaining unit 514 obtains the traveling route of the vehicle 100 from the current position to the destination. In the present embodiment, the traveling route obtaining unit 514 obtains the traveling route from the current place to the destination by searching for the traveling route using map information stored in the map information storage unit 521. The traveling route obtaining unit 514 searches for the traveling route by using, for example, the Dijkstra's algorithm or A-star.

The predicted remaining amount obtaining unit 515 obtains a predicted remaining amount which is a prediction value of the energy remaining amount at a point of time at which the vehicle 100 arrives at the destination. In the present embodiment, the predicted remaining amount obtaining unit 515 obtains the predicted remaining amount of the hydrogen gas in the fuel tank 112 based on the length of the traveling route obtained by the traveling route obtaining unit 514 and the travelable distance obtained by the travelable distance obtaining unit 512.

The supply facility information obtaining unit 516 obtains the supply facility information of the at least one supply facility 200 which includes the equipment which supplies the traveling energy to the vehicle 100. In the present embodiment, the supply facility information obtaining unit 516 obtains the pieces of supply facility information of a plurality of supply facilities 200 from the information processing device 310 of the management center 300 via the communicator 130.

The traveling route presenting unit 517 presents the traveling route obtained by the traveling route obtaining unit 514 to the occupant of the vehicle 100. In the present embodiment, the traveling route presenting unit 517 presents the traveling route to the occupant of the vehicle 100 by causing the display unit 530 to display the traveling route.

The route guidance executing unit 518 executes route guidance of the traveling route selected by the occupant by means of a video image displayed on the display unit 530 and a voice output by the voice output unit 550.

The map information storage unit 521 stores the map information in advance. The map information stored in the map information storage unit 521 may be updated to latest map information transmitted from the management center 300 to the vehicle 100.

The registered place input as a storage place of the vehicle 100 is stored in the registered place storage unit 522. For example, a location of a home or a company of the driver is stored as the storage place of the vehicle 100 in the registered place storage unit 522.

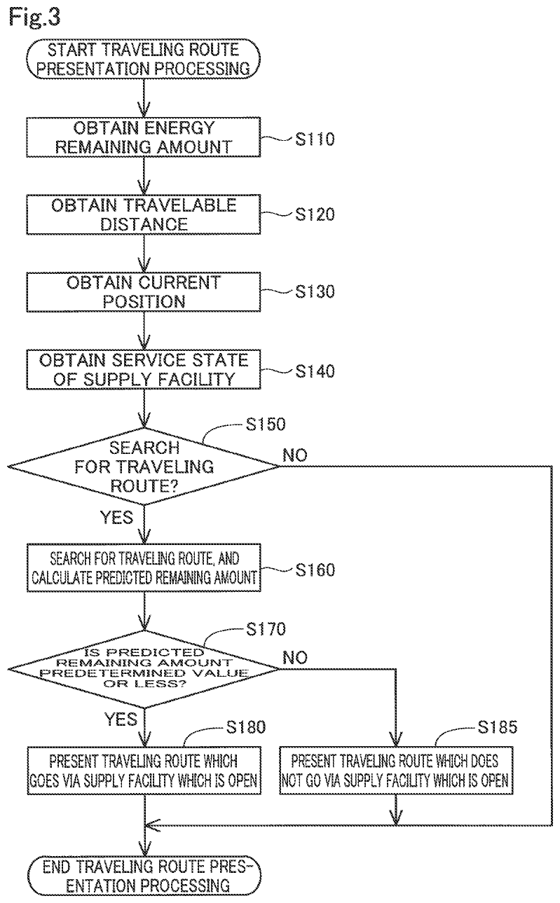

FIG. 3 is a flowchart illustrating contents of route presentation processing. This processing is executed by the control unit 510 when a predetermined start command is input via the operation unit 540 of the navigation device 500.

First, in step S110, the control unit 510 causes the energy remaining amount obtaining unit 511 to obtain the energy remaining amount of the vehicle 100. Next, in step S120, the control unit 510 causes the travelable distance obtaining unit 512 to obtain the travelable distance of the vehicle 100. In this regard, the processing in step S110 is also referred to as an energy remaining amount obtaining process. The processing in step S120 is also referred to as a travelable distance obtaining process.

In step S130, the control unit 510 causes the current position obtaining unit 513 to obtain the current position of the vehicle 100. In this regard, the processing in step S130 is also referred to as a current position obtaining process. The processing in step S130 may be executed before the processing in step S110.

In step S140, the control unit 510 causes the supply facility information obtaining unit 516 to obtain the supply facility information which indicates the service state of the at least one supply facility 200. In the present embodiment, the supply facility information obtaining unit 516 obtains the pieces of supply facility information which indicate the service states of a plurality of supply facilities 200 from the information processing device 310 of the management center 300 via the communicator 130. The supply facility information includes information related to benefits provided by the supply facilities 200 which store the hydrogen gas of a predetermined amount or more for which pre-cooling processing has been finished among a plurality of supply facilities 200 together with the service states of a plurality of supply facilities 200. These benefits are, for example, a discount of a fuel charge, a refund of part of the fuel charge, an offer of various types of service such as car washing or cleaning or an offer of coupons which can be used to pay various charges. The supply facility information may include information which indicates a storage amount of the hydrogen gas of each supply facility 200. In this regard, the processing in step S140 is also referred to as a supply facility information obtaining process. The processing in step S140 may be executed before the processing in step S110, or may be executed between the processing in step S120 and the processing in step S130.

In step S150, the control unit 510 decides whether or not to search for the traveling route. In the present embodiment, the control unit 510 decides to search for the traveling route when the destination is input. When not deciding to search for the traveling route, the control unit 510 finishes this processing. When deciding to search for the traveling route, the control unit 510 causes the traveling route obtaining unit 514 to search for a first traveling route from the current position to the destination, and causes the predicted remaining amount obtaining unit 515 to predict the energy remaining amount of the vehicle 100 at a point of time at which the vehicle 100 arrives at the destination by traveling on the first traveling route in step S160. In the present embodiment, while executing searching for the traveling route, the control unit 510 causes the display unit 530 to display the information related to the benefits included in the supply facility information obtained in step S140. The control unit 510 causes the display unit 530 to display, for example, information related to benefits provided by the supply facilities 200 which are within predetermined distances from the current position of the vehicle 100, or information related to benefits provided by the supply facilities 200 which are within predetermined distances from the destination. In this regard, a process of obtaining the traveling route from the current position of the vehicle 100 to the destination in step S150 is also referred to as a traveling route obtaining process. A process of obtaining the predicted remaining amount of the vehicle 100 at a point of time at which the vehicle 100 arrives at the destination in step S150 is also referred to as a predicted remaining amount obtaining process.

In step S170, the control unit 510 decides whether or not the predicted remaining amount, which is the prediction value of the energy remaining amount predicted by the predicted remaining amount obtaining unit 515, is equal to or less than the value which satisfies the predetermined condition. In the present embodiment, when the predicted remaining amount is an energy remaining amount or less at which the vehicle 100 can travel from the destination to the supply facility 200 which is open now, or when the predicted remaining amount is an energy remaining amount or less at which the vehicle 100 can travel from the destination to a registered place registered in advance as the storage place of the vehicle 100 in the registered place storage unit 522, the control unit 510 decides that the predicted remaining amount is equal to or less than the value which satisfies the predetermined condition.

When not deciding in step S170 that the predicted remaining amount is equal to or less than the value which satisfies the predetermined condition, the control unit 510 causes the traveling route presenting unit 517 to display the first traveling route searched in step S160 on the display unit 530 in step S185. In this regard, the processing in step S180 is also referred to as a traveling route presenting process.

When deciding in step S170 that the predicted remaining amount is equal to or less than the value which satisfies the predetermined condition, the control unit 510 causes the traveling route presenting unit 517 to display a second traveling route which goes via the supply facility 200 which exists within a travelable range of the vehicle 100 on the display unit 530 in step S180. In the present embodiment, when there are a plurality of supply facilities 200 which are open now within the travelable range of the vehicle 100, the control unit 510 causes the display unit 530 to display as the second traveling route a traveling route which goes via the supply facility 200 and minimizes an increase amount of a length of the traveling route or an increase amount of a time during which the vehicle 100 travels on the traveling route among a plurality of supply facilities 200 compared to the first traveling route searched in step S160. The occupant of the vehicle 100 can switch whether to cause the display unit 530 to display as the second traveling route the traveling route which minimizes the increase amount of the length of the traveling route and goes via the supply facility 200, or to display as the second traveling route the traveling route which minimizes the increase amount of the time during which the vehicle 100 travels on the traveling route and goes via the supply facility 200 by operating the operation unit 540. In this regard, the processing in step S185 is also referred to as a traveling route presenting process.

After step S180 or step S185, the control unit 510 finishes this processing. Subsequently, the control unit 510 causes the route guidance executing unit 518 to start route guidance of the first traveling route or the second traveling route.

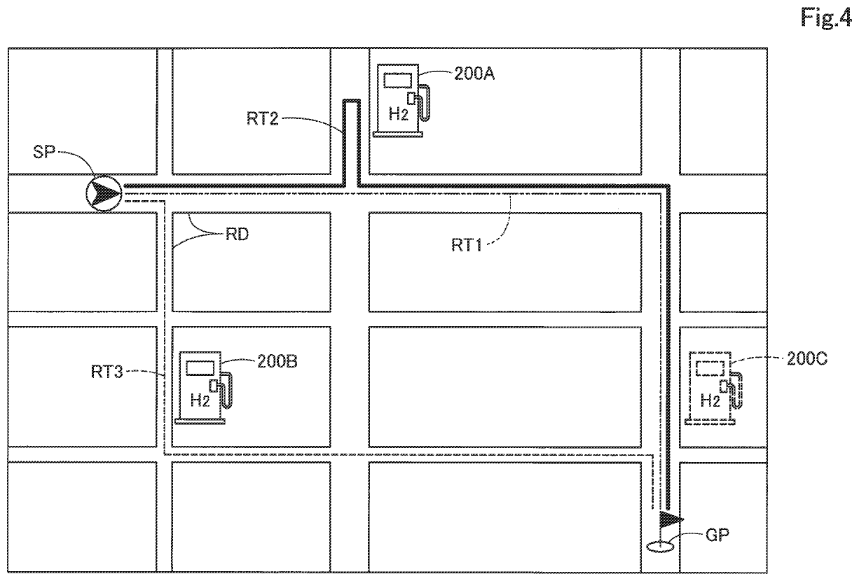

FIG. 4 is an explanatory view illustrating an example of the traveling route presented by the navigation device 500. FIG. 4 illustrates a current position SP of the vehicle 100, a destination GP, a road RD, three supply facilities 200A to 200C and three traveling routes RT1 to RT3. The supply facility 200A and the supply facility 200B are open. The supply facility 200C is closed or under maintenance.

When the prediction value at a point of time at which the vehicle 100 arrives at the destination in a case where the vehicle 100 does not go via the supply facilities 200A to 200C exceeds a value which satisfies the predetermined condition, the control unit 510 presents the traveling route RT1 which does not go via the supply facilities 200A to 200C. When the predicted remaining amount at the point of time at which the vehicle 100 arrives at the destination in a case where the vehicle 100 does not go via the supply facilities 200A to 200C is equal to or less than the value which satisfies the predetermined condition, the control unit 510 presents the traveling route RT2 which goes via the supply facility 200A, or the traveling route RT3 which goes via the supply facility 200B. The traveling route RT2 goes via the supply facility 200A, and therefore includes a part which goes in a direction opposite to the destination. In the traveling route RT2, only the road RD whose speed limit is relatively high is travelled. A traveling distance of the traveling route RT3 is the substantially same as a traveling distance of the traveling route RT1. In the traveling route RT3, the roads RD whose speed limits are relatively low are frequently used to be travelled. Hence, when a minimum increase amount of a traveling time is set to the traveling route RT1, the traveling route RT2 which minimizes the increase amount of the traveling time is presented. When the minimum increase amount of a traveling distance is set to the traveling route RT1, the traveling route RT3 which minimizes the increase amount of the traveling distance is presented.

According to the navigation device 500 according to the above-described present embodiment, when there is few extra predicted remaining amount of the fuel of the vehicle 100 at a point of time at which the vehicle 100 arrives at the destination, the control unit 510 can encourage the occupant of the vehicle 100 to supply the traveling energy by presenting the traveling route which goes via the supply facility 200. Consequently, it is possible to reserve the extra fuel remaining amount of the vehicle 100 at a point of time at which the vehicle 100 arrives at the destination. Furthermore, the traveling route which goes via the supply facility 200 which is open now or at a point of time at which the vehicle 100 arrives at the supply facility 200 is presented, so that it is possible to eliminate a labor of the occupant of the vehicle 100 for checking whether or not the supply facility 200 is open.

Furthermore, according to the present embodiment, when a fuel which enables the vehicle 100 to travel from the destination to the supply facility 200 which is open now or from the destination to a registered place registered in advance as the storage place of the vehicle 100 is not reserved, the control unit 510 presents the traveling route which goes via the supply facility 200 which is open now. Consequently, it is possible to easily present the traveling route without predicting a time at which the vehicle 100 arrives at the supply facility 200.

Furthermore, according to the present embodiment, the supply facility information obtaining unit 516 obtains service states of a plurality of supply facilities 200, and, when a plurality of supply facilities 200 are open now or at a point of time at which the vehicle 100 arrives, the traveling route obtaining unit 514 presents the supply facility 200 which minimizes an increase amount of a length of the traveling route or an increase amount of a time during which the vehicle 100 travels on the traveling route among a plurality of supply facilities 200 which are open compared to a traveling route which does not go via the supply facility 200. Consequently, it is possible to suppress an increase in the traveling distance from the current position to the destination, or delay of an arrival time at the destination.

Furthermore, according to the present embodiment, the hydrogen station which is the supply facility 200 includes the equipment 210 which supplies to the vehicle 100 a cooled hydrogen gas which is a hydrogen gas cooled to a preset temperature, and provides the information related to the benefit to the occupant of the vehicle 100 when the cooled hydrogen gas of a preset amount or more is stored in the equipment 210. Consequently, it is possible to encourage the occupant of the vehicle 100 to supply the hydrogen to the vehicle 100 at the supply facility 200 in which the cooled hydrogen gas is stored, so that it is possible to reduce a waste of energy for cooling the hydrogen gas in the supply facility 200.

### B. Other Embodiment

(B1) In the route guidance system 10 according to the above-described first embodiment, the control unit 510 of the navigation device 500 mounted on the vehicle 100 may decide in step S170 in FIG. 3 that, when an energy remaining amount is equal to or less than an energy remaining amount which enables the vehicle 100 to travel from the destination to the supply facility 200 which is open at a point of time at which the vehicle 100 arrives at the supply facility 200 or from the destination to the registered place registered in advance as the storage place of the vehicle, the predicted remaining amount is equal to or less than the value which satisfies the predetermined condition. In this case, it is possible to reduce a probability that the supply facility 200 finishes operating before the vehicle 100 arrives at the supply facility 200, and the vehicle 100 cannot receive a supply of the traveling energy. Furthermore, a stay time at the destination or an estimated time to departure from the destination may be input to the control unit 510, and the control unit 510 may predict the time at which the vehicle 100 arrives at the supply facility 200, and decide whether or not the supply facility 200 is open at the point of time at which the vehicle 100 arrives at the supply facility 200 from the destination. In this case, it is possible to further reduce the probability that the vehicle 100 cannot receive a supply of the traveling energy.

(B2) In the route guidance system 10 according to the above-described first embodiment, the traveling route obtaining unit 514 of the navigation device 500 mounted on the vehicle 100 executes searching for the traveling route. By contrast with this, information of the energy remaining amount, the travelable distance, the current position and the destination may be transmitted from the navigation device 500 to the management center 300, the information processing device 310 of the management center 300 may search for a traveling route, and the traveling route obtaining unit 514 may obtain the traveling route transmitted from the management center 300.

(B3) In the route guidance system 10 according to the above-described first embodiment, when there are a plurality of supply facilities 200 which are open now within a travelable range of the vehicle 100, the control unit 510 of the navigation device 500 mounted on the vehicle 100 presents as the second traveling route a traveling route which goes via the supply facility 200 and minimizes the increase amount of the length of the traveling route or the increase amount of the time during which the vehicle 100 travels on the traveling route compared to the first traveling route. By contrast with this, when there are a plurality of supply facilities 200 which are open now within the travelable distance of the vehicle 100, the control unit 510 may present the second traveling route different from the above-described traveling route. For example, the control unit 510 may present as the second traveling route a traveling route which minimizes a total value of a value obtained by multiplying a predetermined weight coefficient on the increase amount of the length of the traveling route, and a value obtained by multiplying a predetermined weight coefficient on the increase amount of the time during which the vehicle 100 travels on the traveling route. In this regard, when a difference between total values of two traveling routes is equal to or less than a predetermined value, the control unit 510 may present the traveling route whose height in difference is less as the second traveling route.

(B4) In the route guidance system 10 according to the above-described first embodiment, the supply facilities 200 which store hydrogen gases of predetermined amounts for which the pre-cooling processing has been finished provide the information related to the benefits to the occupant of the vehicle 100. By contrast with this, the supply facilities 200 which store hydrogen gases of predetermined amounts for which the pre-cooling processing has been finished may not provide the information related to the benefits to the occupant of the vehicle 100.

(B5) The route guidance system 10 according to the above-described first embodiment includes the management center 300, and the supply facility information is provided from the supply facility 200 to the vehicle 100 via the management center 300. By contrast with this, the route guidance system 10 may not include the management center 300, and the supply facility information may be provided from the supply facility 200 to the vehicle 100.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) One aspect of the present disclosure provides a navigation device of a vehicle. This navigation device includes: a display; and a controller configured to obtain a first remaining amount which is an energy remaining amount of traveling energy of the vehicle, obtain a travelable distance of the vehicle at the first remaining amount, obtain a current position of the vehicle, obtain a first traveling route from the current position to a destination, obtain a predicted remaining amount which is calculated based on a length of the first traveling route and the travelable distance and is a prediction value of the energy remaining amount at a point of time at which the vehicle arrives at the destination, obtain supply facility information which indicates a service state of at least one supply facility including equipment which supplies the traveling energy to the vehicle, and display a traveling route from the current position to the destination on the display, wherein the controller displays the first traveling route on the display when the predicted remaining amount exceeds a second remaining amount which is the energy remaining amount which satisfies a preset condition, and displays a second traveling route from the current position to the destination via the supply facility whose service state is open now or at a point of time at which the vehicle arrives at the supply facility on the display when the predicted remaining amount is the second remaining amount or less.

According to the navigation device according to this aspect, when the predicted remaining amount is the second remaining amount or less which satisfies the preset condition, the controller displays the second traveling route which goes via the supply facility which is open now or at the point of time at which the vehicle arrives at the supply facility on the display instead of the first traveling route. Consequently, it is possible to prevent the energy remaining amount of the vehicle at the point of time at which the vehicle arrives at the destination from becoming scarce. Furthermore, the controller displays the second traveling route which goes via the supply facility which is open now or at the point of time at which the vehicle arrives at the supply facility on the display, so that it is possible to eliminate a labor of a vehicle occupant for searching for the supply facility which is open.

(2) In the navigation device according to the above aspect, the second remaining amount may be the energy remaining amount at which the vehicle can travel from the destination to the supply facility whose current service state is open or from the destination to a registered place registered in advance as a storage place of the vehicle.

The navigation device according to this aspect displays the second traveling route which goes via the supply facility which is open now, so that it is possible to easily display the second traveling route without predicting the time at which the vehicle arrives at the supply facility.

(3) In the navigation device according to the above aspect, the second remaining amount may be the energy remaining amount at which the vehicle can travel from the destination to the supply facility whose service state is open at a point of time at which the vehicle arrives at the supply facility or from the destination to a registered place registered in advance as a storage place of the vehicle.

The navigation device according to this aspect displays the second traveling route which goes via the supply facility which is open at the point of time at which the vehicle arrives at the supply facility, so that it is possible to reduce a probability that the supply facility finishes operating before the vehicle arrives at the supply facility, and the vehicle cannot receive an energy supply.

(4) In the navigation device according to the above aspect, the controller may obtain the supply facility information which indicates the service states of a plurality of the supply facilities, and, when there are the plurality of supply facilities whose service states are open now or at a point of time at which the vehicle arrives, the controller may display a traveling route among the plurality of supply facilities which are open as the second traveling route, the traveling route going via the supply facility and minimizing an increase amount of a length of a traveling route or an increase amount of a time during which the vehicle travels on the traveling route compared to the first traveling route.

The navigation device according to this aspect can minimize the increase amount of the traveling distance caused by passing through the supply facility or the increase amount of the traveling time.

(5) In the navigation device according to the above aspect, the vehicle may be a fuel cell vehicle, and the supply facility may be a hydrogen station which includes the equipment which supplies hydrogen as the traveling energy to the fuel cell vehicle.

The navigation device according to this aspect can reserve an extra hydrogen remaining amount of the fuel cell vehicle at the point of time at which the vehicle arrives at the destination. Furthermore, it is possible to eliminate a labor of the vehicle occupant for searching for the hydrogen station which is open.

(6) In the navigation device according to the above aspect, the hydrogen station may include the equipment which supplies, to the fuel cell vehicle, cooled hydrogen which is the hydrogen cooled to a preset temperature, and, when the cooled hydrogen of a preset amount or more is stored in the equipment of the hydrogen station, the supply facility information may include information related to a benefit provided by the hydrogen station.

The navigation device according to this aspect can encourage the occupant of the fuel cell vehicle to supply hydrogen to the fuel cell vehicle at the hydrogen station at which the cooled hydrogen is stored, so that it is possible to reduce a waste of energy for cooling hydrogen.

The present disclosure can be also realized by various aspects other than the navigation device. The present disclosure can be realized by aspects such as a navigation method and a route guidance system.

What is claimed is:

1. A navigation device of a vehicle comprising:
a display; and
a controller configured to obtain a first remaining amount which is an energy remaining amount of traveling energy of the vehicle,
obtain a travelable distance of the vehicle at the first remaining amount,
obtain a current position of the vehicle,
obtain a first traveling route from the current position to a destination,
obtain a predicted remaining amount which is calculated based on a length of the first traveling route and the travelable distance and is a prediction value of the energy remaining amount at a point of time at which the vehicle arrives at the destination,
obtain supply facility information which indicates a service state of at least one supply facility including equipment which supplies the traveling energy to the vehicle, and
display a traveling route from the current position to the destination on the display,
wherein the controller
displays the first traveling route on the display when the predicted remaining amount exceeds a second remaining amount which is the energy remaining amount which satisfies a preset condition, and
displays a second traveling route from the current position to the destination via the supply facility whose service state is open now or at a point of time at which the vehicle arrives at the supply facility on the display when the predicted remaining amount is the second remaining amount or less.

2. The navigation device according to claim 1, wherein
the second remaining amount is the energy remaining amount at which the vehicle can travel from the destination to the supply facility whose current service state is open or from the destination to a registered place registered in advance as a storage place of the vehicle.

3. The navigation device according to claim 1, wherein
the second remaining amount is the energy remaining amount at which the vehicle can travel from the destination to the supply facility whose service state is open at a point of time at which the vehicle arrives at the supply facility or from the destination to a registered place registered in advance as a storage place of the vehicle.

4. The navigation device according to claim 1, wherein
the controller obtains the supply facility information which indicates the service states of a plurality of the supply facilities, and
when there are the plurality of supply facilities whose service states are open now or at a point of time at which the vehicle arrives, the controller displays a traveling route among the plurality of supply facilities which are open as the second traveling route, the traveling route via the supply facility and minimizing an increase amount of a length of a traveling route or an increase amount of a time during which the vehicle travels on the traveling route compared to the first traveling route.

5. The navigation device according to claim 1, wherein
the vehicle is a fuel cell vehicle, and
the supply facility is a hydrogen station which includes the equipment which supplies hydrogen as the traveling energy to the fuel cell vehicle.

6. The navigation device according to claim 5, wherein
the hydrogen station includes the equipment which supplies, to the fuel cell vehicle, cooled hydrogen which is the hydrogen cooled to a preset temperature, and
when the cooled hydrogen of a preset amount or more is stored in the equipment of the hydrogen station, the supply facility information includes information related to a benefit provided by the hydrogen station.

7. A navigation method of a vehicle comprising:
obtaining a first remaining amount which is an energy remaining amount of traveling energy of the vehicle;
obtaining a travelable distance of the vehicle at the first remaining amount;
obtaining a current position of the vehicle;
obtaining supply facility information which indicates a service state of at least one supply facility including equipment which supplies the traveling energy to the vehicle;
obtaining a first traveling route from the current position to a destination;
obtaining a predicted remaining amount which is calculated based on a length of the first traveling route and the travelable distance and is a prediction value of the energy remaining amount at a point of time at which the vehicle arrives at the destination; and
presenting a traveling route from the current position to the destination;
wherein the presenting
presents the first traveling route when the predicted remaining amount exceeds a second remaining amount which is the energy remaining amount which satisfies a preset condition, and
presents a second traveling route from the current position to the destination via the supply facility whose service state is open now or at a point of time at which the vehicle arrives at the supply facility when the predicted remaining amount is the second remaining amount or less.

8. The navigation method according to claim 7, wherein
the second remaining amount is the energy remaining amount at which the vehicle can travel from the destination to the supply facility whose current service state is open or from the destination to a registered place registered in advance as a storage place of the vehicle.

9. The navigation method according to claim 7, wherein
the second remaining amount is the energy remaining amount at which the vehicle can travel from the destination to the supply facility whose service state is open at a point of time at which the vehicle arrives at the supply facility or from the destination to a registered place registered in advance as a storage place of the vehicle.

10. The navigation method according to claim 7, wherein
the obtaining obtains the supply facility information which indicates the service states of a plurality of the supply facilities, and
when there are the plurality of supply facilities whose service states are open now or at a point of time at which the vehicle arrives, the presenting presents a traveling route among the plurality of supply facilities which are open as the second traveling route, the traveling route via the supply facility and minimizing an increase amount of a length of a traveling route or an increase amount of a time during which the vehicle travels on the traveling route compared to the first traveling route.

11. The navigation method according to claim 7, wherein
the vehicle is a fuel cell vehicle, and
the supply facility is a hydrogen station which includes the equipment which supplies hydrogen as the traveling energy to the fuel cell vehicle.

12. The navigation method according to claim 11, wherein
the hydrogen station includes the equipment which supplies, to the fuel cell vehicle, cooled hydrogen which is the hydrogen cooled to a preset temperature, and
when the cooled hydrogen of a preset amount or more is stored in the equipment of the hydrogen station, the supply facility information includes information related to a benefit provided by the hydrogen station.
